(19) United States
(12) Patent Application Publication
(10) Pub. No.: US 2006/0231309 A1
(43) Pub. Date: Oct. 19, 2006

(54) Ergonomic plow control system

(76) Inventor: John A. Lashua, Iola, WI (US)

Correspondence Address: CHRISTOPHER JOHN RUDY, 209 HURON AVENUE, SUITE 8, PORT HURON, MI, 48060, US

(21) Appl. No.: 11/378,186

(22) Filed: Mar. 17, 2006

Related U.S. Application Data
(60) Provisional application No. 60/664,486, filed on Mar. 23, 2005.

(51) Int. Cl. B62D 33/06

(52) U.S. Cl. 180/89.12

(57) ABSTRACT

System includes control housing and a switch pad having keys, which can be highly unobtrusive and/or be very soft and flexible, and a transmitter housing in communication with the control housing. The communication can be through a pig tail wire bundle. A set of radially disposed keys can be provided.

This claims benefits under 35 USC 119(e) of application No. 60/664,486 filed on Mar. 23, 2005 A.D. Its complete specification is incorporated herein by reference.

### FIELD OF THE INVENTION

The present invention concerns a plow control system. In particular, it concerns a snow plow control system for a vehicle equipped with a plow such as for plowing snow.

### BACKGROUND TO THE INVENTION

Plowing snow from large parking lots with a plowing vehicle can be long in duration, demanding of attention and response, and tiresome for the operator. In address of problems in the art, Lashua, U.S. Pat. No. 6,852,934 and Pub. No. 2005/0039968, provided ergonomic snow plow control systems.

It would be desirable nonetheless to further improve the art. It would be desirable to provide snow plow systems, to include those of Lashua, with better characteristics and performance.

### DISCLOSURE OF THE INVENTION

In general, the present invention provides an ergonomic plow control system, which, in one embodiment, comprises a control housing and a switch pad having keys, which can be highly unobtrusive and/or be very soft and flexible, and a transmitter housing in communication with the control housing. In another embodiment, the system includes a housing and switch pad with a set of radially endowed keys.

The invention is useful in conjunction with plowing, to include snow.

Significantly, by the invention, the art is improved further and in kind, and snow plow control systems, to include those of Lashua, can be provided with better ergonomic characteristics and performance. In certain embodiments, employment of all highly miniaturized electronic components can be avoided, in favor of the employment of more common electronic components that are not so highly miniaturized, even while keeping the part of the system in contact with the operator's hand at a small, unobtrusive size.

Numerous further advantages attend the invention.

The drawings form part of the specification hereof. With respect to the drawings, which are not necessarily drawn to scale, the following is briefly noted:

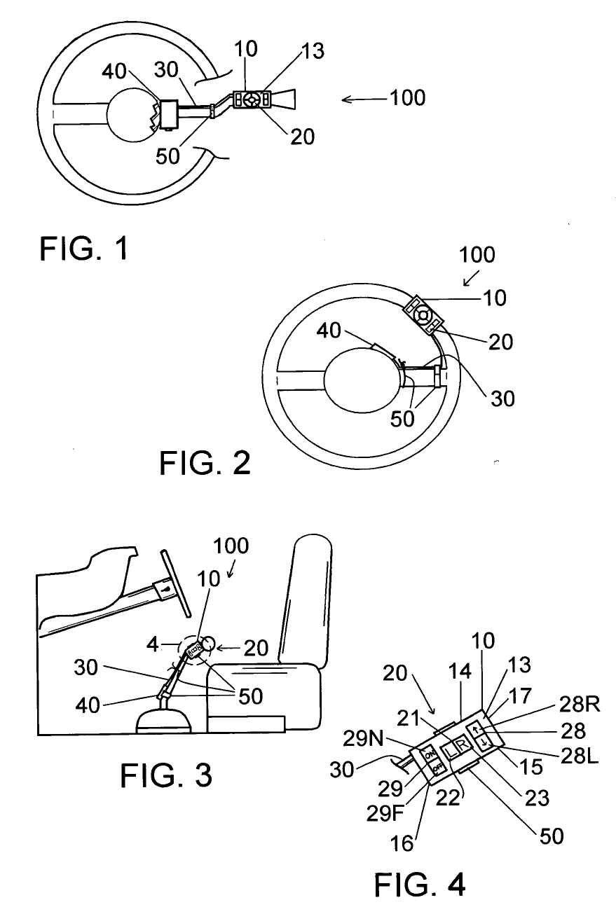

FIG. 1 is a plan view of an embodiment of an ergonomic plow control system of the invention, for control of a V-plow, the control housing of which is attached to a more central portion of a column gear shift lever of a plowing vehicle, and the transmitter housing of which is attached to a more central portion of the gear shift lever.

FIG. 2 is a plan view of a system generally as of FIG. 1, with its control housing attached to the rim of a steering wheel of the plowing vehicle, and its transmitter housing attached to the hub of the steering wheel or to the steering wheel shaft console.

FIG. 3 is a plan view of another embodiment of the invention, for control of a straight plow, with its control housing attached to an upper portion of a floor gear shift lever of the plowing vehicle, and its transmitter housing attached to a lower portion of the gear shift lever.

FIG. 4 is a detailed view of the control housing in FIG. 3, as within circle 3.

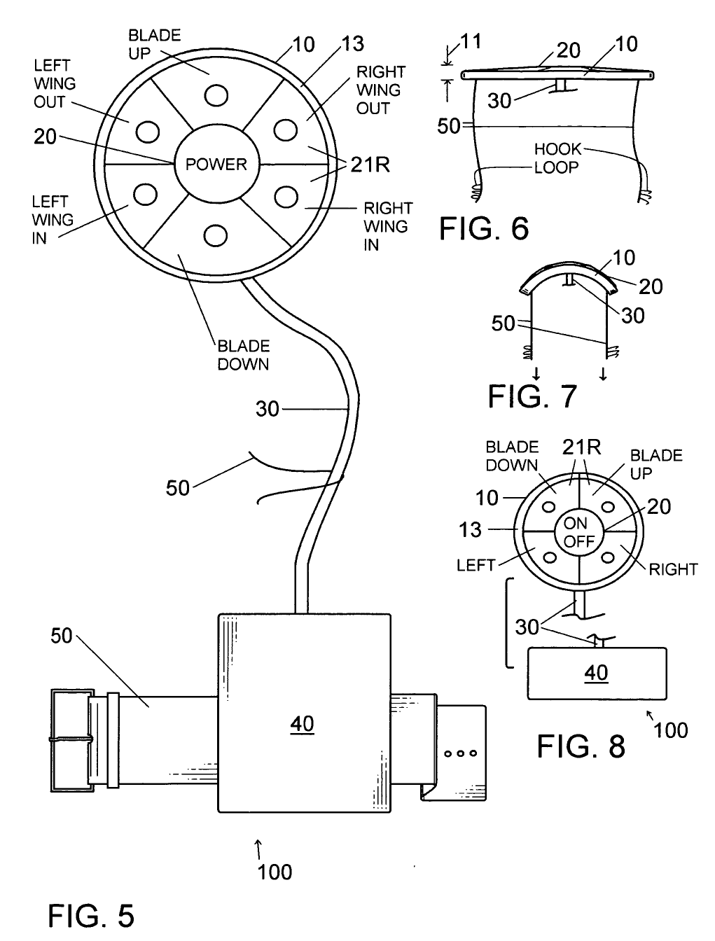

FIG. 5 is a plan view of another embodiment of the invention with separate control and transmitter housings, and having a set of radially disposed keys associated with the control housing. This embodiment is configured especially for V-plow control.

FIG. 6 is a side plan view of the control housing of FIG. 5.

FIG. 7 is a side plan view of the control housing of FIG. 5, taken in the same direction as the view of FIG. 6, but pulled into a flexed configuration.

FIG. 8 is a plan view of an embodiment analogous to that of FIG. 5 but configured especially for control of a straight plow.

The invention can be further understood by the detail set forth below, which may be read in view of the drawings. The same is to be taken in an illustrative and not necessarily limiting sense.

With reference to the drawings, ergonomic plow control system 100 includes plastic control housing 10 with key pad 20. Electronic communication link 30 links the control housing 10 with metal or plastic transmitter housing 40.

The control housing 10 can be flexible and very thin, with thickness 11, say, of the housing 10 and key pad 20 of ½ of an inch of less, ⅜ of an inch or less, ¼ of an inch or less, or even ⅛ of an inch or less. Such dimensions may be considered to be exact or approximate. The housing 10 can include an interior with a cavity, and face 13. The housing 10 can be of any suitable shape, to include polygonal, say, rectangular having first and second opposing sides 14, 15 and third and fourth opposing sides 16, 17 normal to the sides 14, 15 (FIGS. 1-4), or curvilinear, to include substantially rounded polygons, egg-shapes, ovoid-shapes and ellipses, say, being circular (FIGS. 5-8). An underside is generally present. The housing 10 may be powered by batteries or other suitable source, to include solar and/or external power.

The key pad 20, say, plastic that may be resilient, is generally mounted in the cavity, or is on or makes up the face 13, and has keys or buttons (switch elements) for activation and control of the plow. For instance, as in the foregoing Lashua patent and publication, which are incorporated herein by reference in their entireties, the key pad 20 may have central element 21 divided into two independently actuatable switch elements 22, 23 to control left and right orientation of a plow such as a straight (standard) plow; laterally disposed switch element set 28 can have two switch elements 28L, 28R for controlling vertical adjustment of the plow by lowering it through the switch element 28L and raising it through the switch element 28R; opposing laterally disposed switch element set 29 can control the “on-off” function of the plow hydraulics through two switch element positions 29F for “off” and 29N for “on” (FIG. 4). The key pad 20 may have central element 21 with radially disposed switch elements 21R, say, from four to six, exactly or more or less in number (FIGS. 5-7 and 8). The key pad 20 and/or its switch elements can be illuminated for night time operations and/or to indicate activation of any particular switch element, say, by lighting of that element when it is activated.

The electronic communication link 30 links the control housing 10 with the transmitter housing 40. The linkage may be wireless. Advantageously, however, say, for the sake of reliability under harsh conditions, for ease and economy of construction, and for physical unification of the housings 10, 40 so as to help avoid loss of one or even both of an otherwise physically unconnected set of control and transmitter housings 10, 40, the link 30 is a pig tail wire bundle of any suitable length, advantageously a short length, say, six to twelve inches, which may be considered to be exact or approximate. Such linkage is generally for plow control, but may also include provision for transmitting power from one housing 10, 40 to another 40, 10.

The transmitter housing 40 can be rigid and contain electronics for radio transmission to a receiving box by and for control of the plow, a power “on-off” switch, and so forth. Thus, bulk can be removed from the control housing 10 and key pad 20. The housing 40 may be powered by batteries or other suitable source. For instance, the housing 40 may be powered by solar power with or without a chargeable reserve, or be hooked up to receive power from an external source, which may include a source such as the alternator, generator, or battery of the plowing vehicle.

Mount 50 such as a strap with Velcro® hook and loop components, a strap with a buckle, a tie, which may be of string, of wire or of plastic, and so forth, or even magnetic force or adhesive, may be employed with either or both of the housings 10, 40 and/or a physical electronic communication link 30 such as the pig tail. A bushing or other space occupying contrivance may be employed around a smaller or thinner vehicular part such as a thin gear shift lever, and so forth to take up space so that the mount 50 may more effectively secure one or more of the components 10, 30, 40. Thus, such component(s) of the system 100 can be mounted readily to vehicular parts and kept secure. When the mount 50 is a temporary or reversible type, say, strap(s) with hook and loop components or the buckle, or the tie, and so forth, the system 100 can be removed for safe storage.

Desirably, the system 100 can be stored in the plowing vehicle's glove box.

Preferably, the switch pad housing and key subsystem 10, 20 is very soft and flexible to allow it to wrap around a shift lever, or around a steering wheel component, say, about an outer part. A short pig tail 30 allows the more rigid transmitter housing 40 to be physically attached to the subsystem 10, 20 and be mounted at the base of the shift lever on the floor, on the steering wheel column, near center of the steering wheel, which can include on a central portion of a spoke of a steering wheel if so equipped, and so forth, so as to keep the bulk of the system 100 out of harm's way during operation.

The present invention is thus provided. Various feature(s), part(s), step(s), subcombination(s) and/or combination(s) can be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

I claim:

1. An ergonomic plow control system, which comprises a subsystem of control housing and a switch pad having keys or buttons, which is highly unobtrusive and/or very soft and flexible; and a transmitter housing in communication with the control housing.

2. The system of claim 1, wherein said subsystem and said transmitter housing are in communication through an electronic communication link that includes a pig tail wire bundle.

3. The system of claim 1, wherein said subsystem is about ¼ of an inch or less in thickness, and is very soft and flexible so that it can be wrapped around a shift lever, or around a suitable steering wheel component.

4. The system of claim 2, wherein said subsystem is about ¼ of an inch or less in thickness, and is very soft and flexible so that it can be wrapped around a shift lever, or around a suitable steering wheel component.

5. The system of claim 3, wherein said subsystem is about ⅛ of an inch or less in thickness, and is very soft and flexible so that it can be wrapped around a shift lever, or around a suitable steering wheel component.

6. The system of claim 4, wherein said subsystem is about ⅛ of an inch or less in thickness, and is very soft and flexible so that it can be wrapped around a shift lever, or around a suitable steering wheel component.

7. The system of claim 3, which further includes at least one mount selected from the group consisting of a strap with hook and loop components, a tie, a buckle, and a combination whereof.

8. The system of claim 4, which further includes at least one mount selected from the group consisting of a strap with hook and loop components, a tie, a buckle, and a combination whereof.

9. The system of claim 5, which further includes at least one mount selected from the group consisting of a strap with hook and loop components, a tie, a buckle, and a combination whereof.

10. The system of claim 6, which further includes at least one mount selected from the group consisting of a strap with hook and loop components, a tie, a buckle, and a combination whereof.

11. The system of claim 3, wherein said switch pad has a central element with radially disposed keys or buttons in relation to the central element.

12. The system of claim 4, wherein said switch pad has a central element with radially disposed keys or buttons in relation to the central element.

13. The system of claim 5, wherein said switch pad has a central element with radially disposed keys or buttons in relation to the central element.

14. The system of claim 6, wherein said switch pad has a central element with radially disposed keys or buttons in relation to the central element.

15. The system of claim 7, wherein said switch pad has a central element with radially disposed keys or buttons in relation to the central element.

16. The system of claim 8, wherein said switch pad has a central element with radially disposed keys or buttons in relation to the central element.

17. The system of claim 9, wherein said switch pad has a central element with radially disposed keys or buttons in relation to the central element.

18. The system of claim 10, wherein said switch pad has a central element with radially disposed keys or buttons in relation to the central element.

19. An ergonomic snow plow control system, which comprises a control housing and a switch pad having a set of radially disposed keys.

20. The system of claim 19, wherein said switch pad has a central element with about from four to six radially disposed keys or buttons in relation to the central element.
